(19) United States
(12) Patent Application Publication
(10) Pub. No.: US 2015/0083858 A1
(43) Pub. Date: Mar. 26, 2015

(54) Passenger aircraft overhead bin method

(71) Applicant: Satish Jindel, Sewickley, PA (US)

(72) Inventor: Satish Jindel, Sewickley, PA (US)

(21) Appl. No.: 14/551,159

(22) Filed: Nov. 24, 2014

Related U.S. Application Data
(62) Division of application No. 13/455,189, filed on Apr. 25, 2012.

(51) Int. Cl. B64D 11/00; G06Q 90/00

(52) U.S. Cl. CPC B64D 11/003; G06Q 90/00
USPC 244/118.5

(57) ABSTRACT

A method for utilizing a plurality of overhead bins within a passenger cabin of an aircraft. Each overhead bin is partitioned to form multiple storage spaces therein, wherein a number of storage spaces is equal to at least a number of passenger seats within a seat row. Each storage space is designated with a space number to form a numbered space, wherein each space number is the same as an assigned seat number within the seat row. A passenger is assigned a seat number and thus the corresponding numbered space. Access to the numbered space is controlled such that only a cabin crew member or the passenger with the assigned seat number can open and close the numbered space.

### CROSS REFERENCE TO RELATED APPLICATIONS

The instant application is a divisional application of application Ser. No. 13/455,189, filed Apr. 25, 2012, the contents of which are incorporated herein by reference.

### BACKGROUND

1. Field of the Invention

The instant system and method relates to the design and arrangement of passenger aircraft overhead bins. In particular, described is a bin arrangement and method which provides for bins to be designed, sized and numbered in such quantity so that the passengers are assigned individual bin(s) which are locked and managed by individual passengers and the crew, further resulting invariable travel pricing options.

2. Description of the Related Art

The current method for the design and utilization of overhead bins in aircraft used by passenger airlines for stowage of carry-on baggage is based on an honor system for passengers to stow their bags anywhere in the overhead bins, which are designed in size and length to accommodate carry-on bags for many passengers per bin. While most airlines restrict passengers to one carry-on roll-a-board and one personal item such as a briefcase or ladies purse, the overhead bins are not large enough for all passengers to stow two such items in the overhead bins or even one large roll-a-board for each passenger.

T o manage the size of carry-on roll-a-boards, most airlines have a sizer box at the gates. These sizer boxes are designed to illustrate the maximum size of the carry-on roll-a-board bag. However, some aircraft have different sizes of overhead bins making it impractical to have different sizes of boxes at the gate. Furthermore, the airline gate agents have trouble enforcing the size limitation, and passengers do everything imaginable to bring whatever size of bag they desire to carry-on and to avoid paying the excess baggage fee for checking in the bags.

In the recent years, many airlines have tried to recover the cost of handling check-in bags with a per bag fee for such check-in bags. However, the passengers have found ways to avoid paying such bag fee by carrying both bags on board, thus exacerbating the lack of overhead bin capacity situation. When the passengers are unable to find space for their oversized or extra carry-on bags in the overhead bins, the airlines readily gate check those bags at no charge to avoid arguments with passengers which would further delay departure time. The passengers have learned to exploit this situation thereby undermining the checked baggage fee program.

Furthermore, the current method results in passengers rushing to be the first ones to get on the airplane so they can occupy more than their share of the overhead bin space for their larger items or both carry-on items. With more carry-on bags than the space available in overhead bins, the passengers who board later are forced to check-in even their one carry-on small roll-a-board causing them displeasure and further delaying the flight departure time, exacerbating the departure delay situation.

The aircraft manufacturers are now able to provide larger overhead bins in the newer models of aircraft. As a result, airlines are incurring higher capital and maintenance cost to provide more spacious overhead bins. With the new focus on unbundling airfare with separate charges for checked-in bags and some airlines even looking to charge for carry-on bags, the current overhead bins are not designed to implement a manageable carry-on baggage fee concept.

Finally, since the 9/11 terrorist attack, there is heightened concern about security for air travel which is now managed by Transportation Security Administration of the Federal Government. As a result, while in airports, passengers are regularly reminded of the need to keep their carry-on baggage within sight to avoid unknown people tampering with their baggage. However, once on board and after the carry-on baggage is stowed in overhead bins, the bags are susceptible to being tampered without the knowledge of the owner. In addition, on international flights, passengers carry important immigration and customs documents, which are not secure in the current design of overhead bins.

### SUMMARY

It is the objective of the instant invention to simplify the work of flight crew who are constantly asking and reminding passengers to put larger carry-on luggage in overhead bins and smaller versions under the seat.

It is further an objective to ensure passengers have a fair share of the overhead bin space for their carry-on irrespective of their boarding sequence.

It is further an objective to put the airlines in a better position to charge the passengers for extra overhead bin or charge for checking in the extra carry-on bags at the gate and to assist in the recovery of the cost of carrying bags.

It is further an objective to enhance passengers' confidence in the security and privacy of their carried-on items.

It is further an objective to aid passengers in their understanding of the size requirements for their carry-on luggage.

it is yet another objective of the instant invention to provide for more comfortable seating as the passengers will be encouraged to utilize the secure bins of the instant system as opposed to the areas underneath the passengers' seat, thereby leaving that space open for leg room.

It is further an objective of the instant invention to allow the airline industry the ability to un-bundle pricing for airfare whereby the passengers can just purchase a seat for the passenger, or the seat and the overhead bin, as a result giving the airline a better means of managing the pricing for passengers and bags whether checked-in or carried-on, and further resulting in a reduction of the number and size of bags that passengers bring to the passenger security check points.

It is another objective of the instant invention to create incentive for passengers to carry smaller carry-on bags and disincentive for those who bring excessive carry-on bags.

It is yet another objective of the instant invention to speed up security clearance at security checkpoints and to reduce cost for security screening entities (such as TSA) which will reduce the cost for airlines and thereby the airfare for the passengers.

Accordingly, the invention comprehends a luggage overhead bin system for a passenger cabin of an aircraft, including a plurality of stowage compartments configured to mount on a ceiling of the aircraft within the passenger cabin, wherein an amount of the stowage compartments approximates an amount of passenger seats within the passenger cabin. A compartment number is labeled on each stowage compartment, wherein each compartment number is the same as a passenger seat number. Next, an access control system for limiting access to each stowage compartment is implemented, wherein only a cabin crew member or a passenger assigned with the seat number can open and close the door of the stowage compartment. The access control system has at least one control panel mounted within the passenger cabin exterior to the plurality of stowage compartments. A reader is mounted to each stowage compartment for receiving an input and forwarding the input to the control panel for authentication. A locking mechanism is connected to each stowage compartment for locking and unlocking the stowage compartment, the locking mechanism configured to de-activate in response to a relay from the control panel after the authentication. Further included is a credential given to the passenger for enabling the passenger to provide the input to the reader, wherein the input is compared to an access control list within the control panel for the authentication. The credential can be printed on the passenger ticket or given to the passenger during a boarding process. Finally, the above system allows for a fare structure which differentiates for travel fare without a carry-on piece of luggage from a carry-on fare for travel with the carry-on piece of luggage.

The method for utilizing a plurality of overhead bins within a passenger cabin of an aircraft therefore comprises: partitioning each overhead bin to form multiple compartments therein, wherein a number of compartments for each overhead bin approximates a number of passenger seats within a seat row; designating each compartment with a compartment number to form a numbered compartment, wherein each compartment number is the same as an assigned seat number within the seat row; assigning a passenger with the assigned seat number, as a result assigning the passenger with the corresponding numbered compartment; and, controlling access to the numbered compartment such that only a cabin crew member or the passenger with the assigned seat number can open and close the numbered compartment.

### BRIEF DESCRIPTION OF THE DRAWINGS

FIG. 1 shows a diagrammatic illustration of the side view of a prior art aircraft cabin with typical seating and overhead bin design.

FIG. 2 shows a top plan view of the prior art aircraft cabin of FIG. 1.

FIG. 3 shows a diagrammatic illustration of the side view of an aircraft cabin implementing the instant overhead bin arrangement.

FIG. 4 shows a partial blow-up of the side view of the aircraft cabin implementing one embodiment of the instant overhead bin arrangement.

FIG. 5 shows a partial blow-up of the side view of the aircraft cabin implementing an alternative embodiment of the instant overhead bin arrangement.

FIG. 6 shows a perspective view of the instant overhead bin design, compartmentalized and assigned with seat numbers and a locking mechanism.

FIG. 7 shows an alternative embodiment of the instant overhead bins with removable dividers serving as the partition.

FIG. 8 is a flow chart of the access control system,

FIG. 9 is a flow chart of an alternative embodiment of the access control system.

FIG. 10 shows an example user-interface displaying the size of the overhead bin area for passengers information to manage the size and number of items for their carry-on and to provide option for pricing out the carry-on luggage and any extra carry-on luggage in accordance with the instant system and method.

The flow charts and/or sections thereof represent logic or program flow that can be executed by a specialized device or a computer and/or implemented on computer readable media or the like tangibly embodying the program of instructions. The executions are typically performed on a computer or specialized device as part of a global communications network such as the Internet. For example, a computer typically has a web browser installed for allowing the viewing of information retrieved via a network on the display device. A network may also be construed as a local, ethernet connection or a global digital/broadband or wireless network or cloud computing network or the like. The specialized device may include any device having circuitry or be a hand-held device, including but not limited to a personal digital assistant (PDA), smartphone, or tablet. Accordingly, multiple modes of implementation are possible and “system” as defined herein covers these multiple modes.

### DETAILED DESCRIPTION OF THE PREFERRED EMBODIMENT

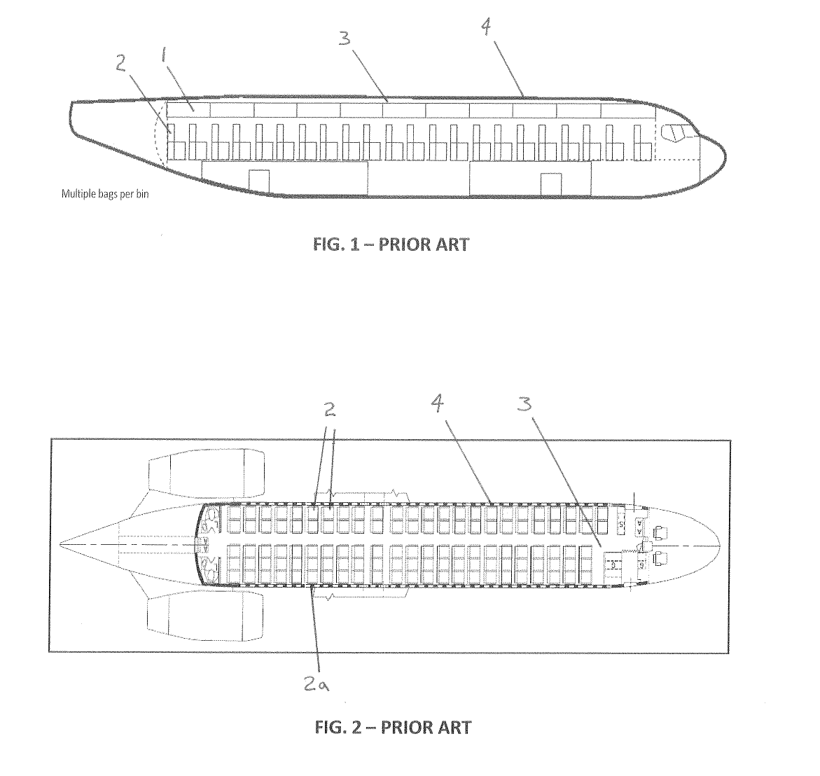

With reference to FIGS. 1 and 2, shown is the prior art design and arrangement of current overhead bins 1 in an aircraft 4 used by passenger airlines. Stowage of carry-on baggage is based on an honor system for passengers to stow their bags anywhere in the overhead bins 1, which are designed in size and length to accommodate carry-on bags for many passengers per bin 1. While most airlines restrict passengers to one carry-on roll-a-board and one personal item such as a briefcase or ladies purse, the overhead bins 1 are not large enough for all passengers to stow two such items in the overhead bins 1 or even one large roll-a-board for each passenger, and, as above, other problems are inherent with the current system.

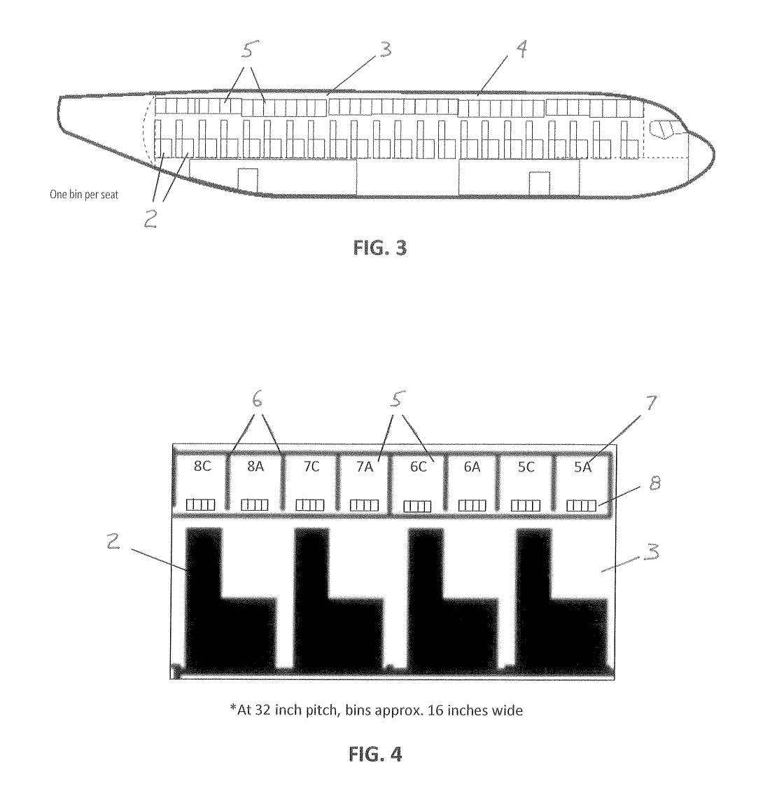

FIGS. 3 through 10 show the instant system and method. In summary, just like the aircraft 4 are designed to have specific seats 2 for each passenger, the proposed system and method provides for a variation in the overhead bins (termed herein compartments 5 for differentiation purposes) to be designed and sized to have an area and length which results in many more compartments 5 such that the number of compartments 5 can be matched with a specific seat 2 below the compartment 5 or within the same row 2a.

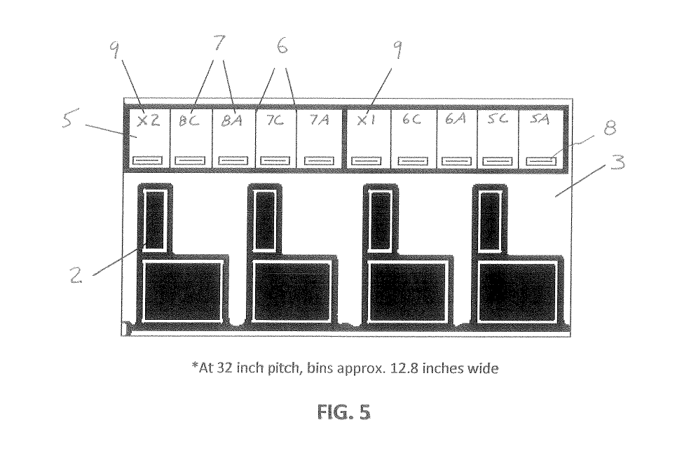

With particular reference to FIGS. 3 through 7, shown is the instant luggage overhead bin system for a passenger cabin 3 of an aircraft 4. Included is a plurality of stowage compartments 5 configured to mount on a ceiling of an aircraft 4 within the passenger cabin 3. It should be understood that although more than one compartment 5 is shown, “a” as used in the claims means one or more since a number of bins or compartments 5 will be determined generally by the length of the aircraft 4, interior arrangement including seats 2 and rows 2a, carry-on baggage requirements, and the spacing of the body frames to which the compartments 5 are attached. Compartments 5 are also impacted by the aircraft model, which can be a regional jet, mainline jet with single aisle seating arrangement or wide-body jet with double aisle seating arrangement. It is further intended that the design of the compartment 5 itself may vary in terms of each individual compartment 5 size and design type. For instance, known is that there are generally three types of overhead stowage bins: shelf, pivot, and translating bins. In a shelf bin the door opens outward and up. The pivot and translating bin designs opens out and down and are common on both single-aisle and twin-aisle aircraft 4. Individual compartment 5 size generally is also determined by the length of the airplane, model, interior arrangement, carry-on baggage requirements, and the spacing of the body frames to which the bins are attached. For instance, standard shelf bins may range in length from 15 to 88 inches. Standard pivot and translating bins may be 15 to 44 inches long. These may obviously vary. Shown in one of the embodiments herein are compartments 5 each having a width of approximately 16 inches, for instance when the typical prior art bin size would be approximately 32 inches (see FIG. 4). Also, shown by FIG. 5 is an alternative embodiment where the instant compartments 5 are approximately 12.8 inches. Critical for the instant invention is the amount or number of the instant stowage compartments 5 must be equal to, or at a minimum approximate the amount of passenger seats within the passenger cabin 3, as further described.

Each compartment 5 is designated with a compartment number 7 to form a numbered compartment 5. “Designated” means the compartment number 7 is simply labeled, tagged, or printed on the compartment 7 such that it is visible and identifiable to the passenger. Critical though is that each compartment number 7 is the same as an assigned seat number within, or at least near, a corresponding seat row 2a. For instance, as is known a passenger is assigned a seat number prior to boarding the aircraft 4. The “number” typically is a numerical digit for the rosy 2a couple with the actual seat letter within the row 2a, e.g. seat 8A. Therefore compartment number 7 as used herein means the identical designation used for the location of the seat 2. As a result, when the passenger is assigned a seat 2, in most instances the passenger is also assigned a corresponding compartment number 7 and thus individual, matching compartment 5. It also avoids passengers having to store their carry-on bags far away from their assigned seat which delays boarding of the aircraft prior to departure and disembarking of the passengers upon landing. In this manner, passengers are not using an honor system to use the compartments 5 (overhead bin space) but instead are utilizing a designated space, i.e. the numbered compartment 5 just as they occupy a designated seat 2 for themselves.

As above, the number of the instant stowage compartments 5 must approximate the amount of passenger seats 2 within the passenger cabin 3. “Approximate” as used herein means in one embodiment there are no extra compartments 5, the number of compartments 5 equaling the amount of seats 2, with each numbered compartment 5 having the same designator or number as a corresponding seat 2. In a further embodiment, “approximate” means there still may be a few seats (1-10 for example, but this number will depend on the model of aircraft, airline preferences, and airline fare structures) that do not include a numbered compartment 5 associated with the seat in the instance the airline elects to sell seats with no overhead space, for example at a discount if the passenger will not have a carry-on requiring an overhead bin. Furthermore, just as is shown by FIG. 5, in one embodiment there may be extra compartments 5, i.e. more compartments 5 than number of passenger seats 2. Extra compartments 5 are termed herein and shown as unassigned bins 9. Unassigned bins 9 do not include a compartment number 7 which match to any particular seat 2, rather they may be labeled with any identifiable designator such as “X2”, “X3”, or similar which differentiates the unassigned bin 9 from the compartments 5. Unassigned bins 9 may be used by crew members for their belongings, safety or first aid equipment, or video equipment, or allocated by the airlines as desirable, for example the unassigned bins 9 can be sold by the airlines and used in accordance with their particular fare structure either as part of the seat 2 or in addition to the seat fare as an extra fee charged for additional carry-ons.

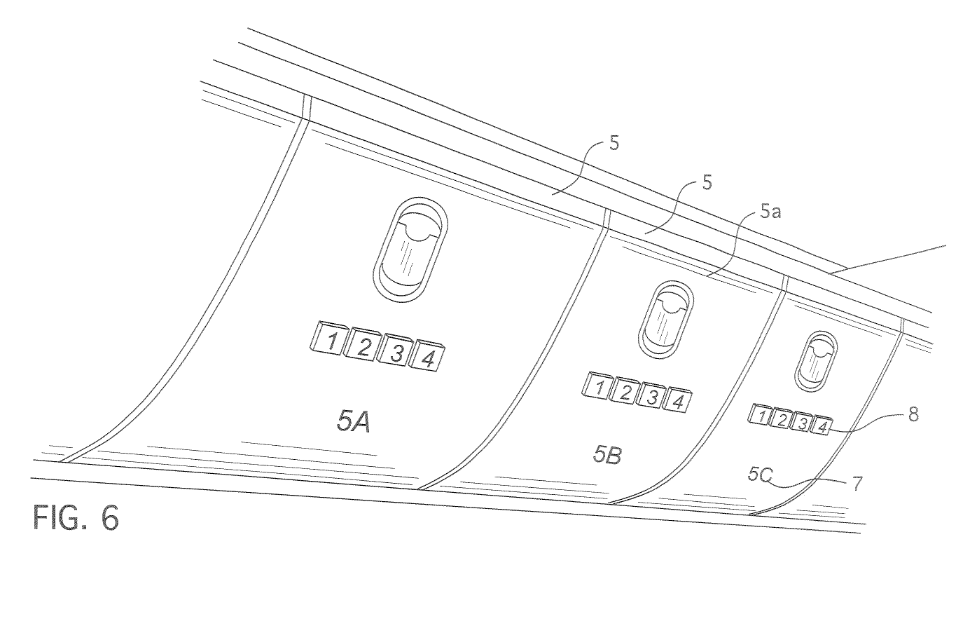

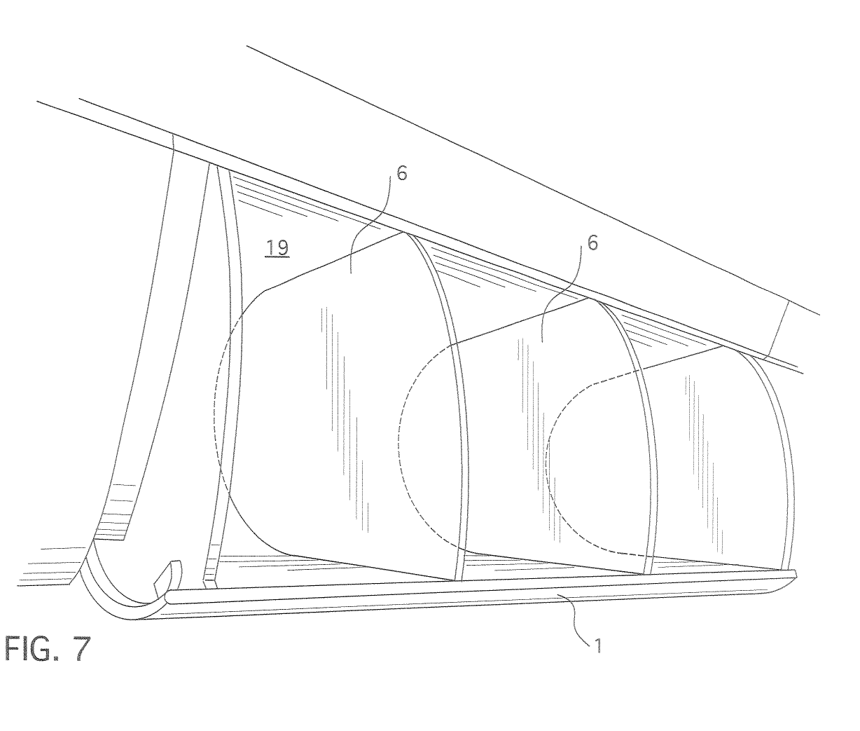

Referencing FIG. 6, each numbered compartment 5 has a door 5a which is locked and unlocked using a locking mechanism 16. Locking mechanism 16 may be mechanical or electromechanical. They may be operated by turning some form of removable key, by keying or dialing in a combination, or further by using technology such as fingerprint detection, reading of barcode or smartcode or via smartphone application) which directly or via electromechanical means operates the locking mechanism 16, or with some form of magnetic or other card reader. In the preferred embodiment and as shown, implemented as the locking mechanism 16 is an electronic lock which operates by means of electric current in response to a coded relay, as further described.

Referencing FIG. 7 with continued reference to FIG. 6, shown is an embodiment of the instant invention wherein space within an existing overhead bin (see 1 of FIG. 1) is partitioned to form multiple storage spaces 19. In the above embodiments the compartments 5 are separate, structural bins, each with a compartment door 5a and separated by a non-removable partition 6. In the embodiment of FIG. 7, the storage spaces 19 are defined by removable partitions 6a within the pre-existing aircraft bin 1 where the existing bin door continues to be utilized to reveal the partitioned, multiple storage spaces 19 with each storage space designated with a space number to form the numbered space. Access is controlled the same way and the door 5a can be locked or unlocked in similar fashion, the difference being access to multiple storage spaces 19 as opposed to individual compartments 5, wherein the number of storage spaces is equal to at least a number of passenger seats within a seat row 2a. The removable partitions 6a can be made of lightweight semi-rigid or rigid material such as plastic and are designed with a shape which conforms to the interior of the overhead bin such that they can be removed and re-located if need be, held in place by friction or with any type of modification within the interior of the overhead bin 1 such as grooves or tabbed slots. In one embodiment the removable partitions 6a are collapsible such that each can fold down onto itself for efficient storage within the overhead bin 1. when not in use. Use of the partitions 6a enable the airlines to assign larger bin areas to accommodate special needs of certain passengers or other desired purpose of the airline.

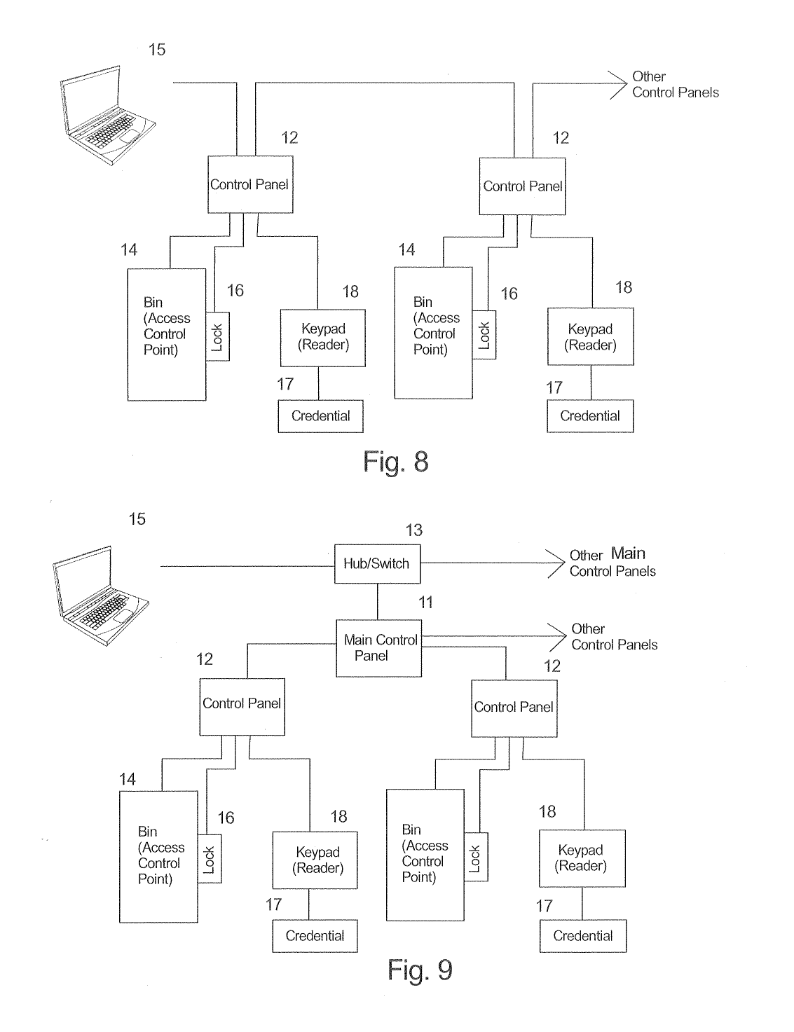

Now with reference to FIGS. 8 and 9, access to the numbered compartments 5 (or storage spaces 19) is preferably controlled such that only a cabin crew member or the passenger with the assigned seat number can open and close the numbered compartment 5. As a means for limiting access to each stowage compartment 5, wherein only a cabin crew member or a passenger can open and close the door of the numbered (stowage) compartment 5, an access control system 10 is provided. Access control system 10 includes at least one control panel 12 mounted within the passenger cabin 3 exterior to the plurality of stowage compartments 5. “Exterior” means anywhere within the cockpit or cabin 3, preferably, for instance, in the flight crew station The control panel 12 is a processer and can be any type of tangible, often vertical, area where control instrumentation is mounted including an interface and patch panel, or the control panel 12 can be any tool within an operating system of a personal computer (PC) 15. PC 15 includes any lap-top or hand-held device such as a personal-digital-assistant (PDA), cellular phone, smart-phone, tablet, or the like.

A reader 18 is mounted (directly at or by connection) to each stowage compartment 5 for receiving an input and forwarding the input to the control panel 12 for authentication, and the locking mechanism 16 is connected to each stowage compartment 5 for locking and unlocking the stowage compartment 16. The locking mechanism 16 is configured to de-activate in response to a relay from the control panel 12 after the authentication of the user (passenger or crew). Specifically, a credential 17 is given to the passenger which can be given at time of booking the flight, payment is made for the ticket, after such ticketing is done, at the airport counter, at the gate or even on board the aircraft, depending on the desired business practice for the specific airline. When the credential 17 is presented to the reader 18, the reader 18 sends the credential's information, in this embodiment a number, to the control panel 12. The control panel 12 compares the credential's number to an access control list, grants or denies the presented request, and sends a transaction log to a database. When access is denied based on the access control list, the access control point 14, here the bin door, remains locked. If there is a match between the credential 17 and the access control list, the control panel 12 operates a relay that in turn unlocks the door (access control point 14). The reader 18 may provide feedback, such as a flashing red LED for an access denied and a flashing green LED for an access granted, or similar.

The credential 17 may be a tangible object or piece of knowledge, and in the preferred embodiment is a 4-digit (can be 3, 5 or any # of digits/letters/symbols, etc. as desired) code which is given or displayed to the passenger prior to boarding. The credential 17 can be provided (printed or displayed) directly on the ticket or e-ticket (“ticket”) or given to the passenger after purchase of the ticket, for instance at any time a seat is assigned at or before boarding. A credential 17 may be any card or other key. In any case the credential 17 takes the form of a code, and this code is entered into the reader 18. As shown here the reader 18 is a keypad on the compartment door 5a where the code is entered, the combination length of which may vary. Since the credentials 17 are system-generated, for security reasons the flight crew can, with or without the codes, gain access to individual bins, override the system using any type of input into the control panel 12, or even lock and unlock all bins simultaneously. Crew access to the control panel 18 can also be password protected or rendered secure by any type of authentication device or program.

As above, control decisions are made by comparing the credential 17 to an access control list of the control panel 12. However, it should be understood that this lookup can be done by a host or server, or even by the reader 18. If the lookup and control functions are by the control panel 12, the spokes communicate through a serial connection such as RS485, as shown. If directly by a reader 18, the lookup is pushed out from a central host to the reader 18, in which case an IP reader can be used (not shown).

FIG. 9 shows an embodiment of the access control system 10 wherein a network-enabled main controller 11 can be used, networked through hub/switch 13. An on-bound network interface may offer improvements or advantages. For instance the transmission could be faster, no special hardware is required, and a means is provided for ring into the existing network of the airline without interrupting normal operations.

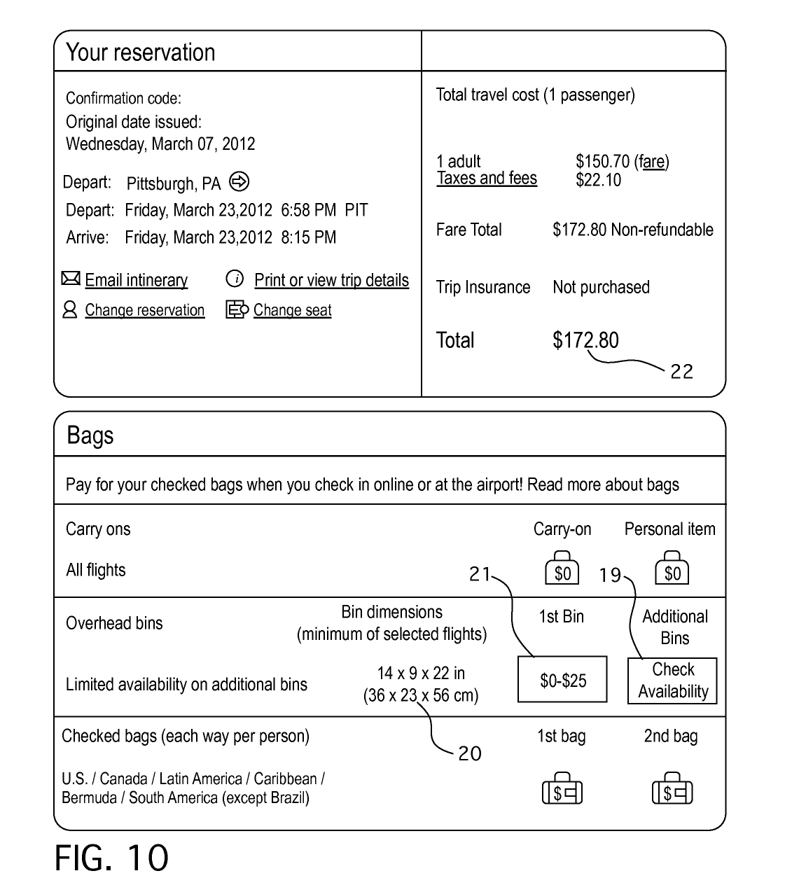

Now referencing FIG. 10, shown is an example user-interface displaying the size and area of the overhead bin provided per seat based on the specific airfare and option for pricing out the carry-on luggage and any extra carry-on luggage in accordance with the instant system and method. The airline can set the dimensions, weight and other attributes 20 of the overhead bin for the flight available on the website to the passengers in conjunction with or after the purchase of seat, seat selection and/or assignment. The information on overhead bin is shared the passengers to help them bring the right type of carry-on bag or bags that can fit inside the overhead bin just as they know about the seat size for passenger seating. Not only desirable for security reasons, but access to the control panel can also be utilized by the flight crew for revenue generation by allowing the flight crew to input additional charges 21 incurred by a passenger for the use of the compartment, use of an additional, unassigned bin 9 (FIG. 5 also), or if the standard travel fare 22 did not initially include a carry-on fee, should the passenger later desire access to a bin/stowage compartment, the passenger can make a compartment purchase during or after boarding and the flight crew can input the charge for the bin fee. Therefore, airlines can manage the assignment of the overhead bins if the airline wishes to establish a fare structure of prices for utilization of overhead bins with further un-bundling of the airfare. “Travel fare” means the standard fare for a passenger who will not be using the compartment, whereas a “carry-on fare” could be a slightly greater fare charged to a passenger with a carry-on who intends to utilize the compartment. In other words, this variable fare structure differentiates between the travel fare for travel without a carry-on piece of luggage from a carry-on fare for travel with the carry-on piece of luggage (of the type demanding usage of the bin) and bin fee. As a result, the instant system and method allows the airline industry the ability to un-bundle pricing for airfare, giving the airline a better means of managing the pricing for passengers and bags whether checked-in or carried on, and further resulting in a reduction of the number and size of bags that passengers bring to the passenger security check points.

I claim:

1. A method for utilizing a plurality of overhead bins within a passenger cabin of an aircraft, comprising the steps of:
partitioning each said overhead bin to form multiple storage spaces therein, wherein a number of storage spaces for each said overhead bin is equal to at least a number of passenger seats within a seat row;
designating each said storage space with a space number to form a numbered space, wherein each said space number is the same as an assigned seat number within said seat row;
assigning a passenger with said assigned seat number, as a result assigning said passenger with said corresponding numbered space; and,
controlling access to said numbered space such that only a cabin crew member or said passenger with said assigned seat number can open and close said numbered space.

2. The method of claim 1, wherein for the step of partitioning, a removable partition is situated within said overhead bin.

3. The method of claim 2, wherein said removable partition is collapsible.

4. The method of claim 1 further comprising the step of giving a credential to said passenger to authenticate said passenger for said access.

5. The method of claim 4, wherein for the step of giving said credential, said credential is displayed on a passenger ticket.

6. The method of claim 4, wherein for the step of giving said credential, said credential is given to said passenger before a boarding process.

7. The method of claim 4, wherein for the step of giving said credential, said credential is given to said passenger after a boarding process.

8. The method of claim 1, further comprising the step of charging a bin fee to said passenger for use of said numbered space.

9. The method of claim 8, wherein said bin fee is unbundled from a standard airfare.
